(19) United States
(12) Patent Application Publication
(10) Pub. No.: US 2018/0369754 A1
(43) Pub. Date: Dec. 27, 2018

(54) AERATION TUBE AND FILTRATION UNIT

(71) Applicant: SUMITOMO ELECTRIC INDUSTRIES, LTD., Osaka-shi, Osaka (JP)

(72) Inventors: Takaki MATSUMOTO, Sennan-gun, Osaka (JP); Toru MORITA, Sennan-gun, Osaka (JP); Kiyoshi IDA, Sennan-gun, Osaka (JP); Hiromu TANAKA, Sennan-gun, Osaka (JP)

(73) Assignee: SUMITOMO ELECTRIC INDUSTRIES, LTD., Osaka-shi, Osaka (JP)

(21) Appl. No.: 16/064,070

(22) PCT Filed: Jan. 9, 2017
(86) PCT No.: PCT/JP2017/000356

§ 371 Date: Jun. 20, 2018

(30) Foreign Application Priority Data
Jan. 22, 2016 (JP) 2016-010952

(51) Int. Cl. B01D 61/20; B01D 63/04; B01D 65/02; B01D 61/18; B01D 39/08

(52) U.S. Cl. CPC B01D 61/20; B01D 63/04; B01D 65/022; B01D 2315/06; B01D 39/08; B01D 2321/185; B01D 61/18

(57) ABSTRACT

An aeration tube according to the present invention, which is configured to supply a cleaning gas for a filtration unit, includes a straight tubular aeration portion, into one end of which the cleaning gas is force-fed and which has a plurality of aeration holes, and a tubular solid content discharge portion which extends from another end of the aeration portion. In a vertical cross section including a central axis of the aeration portion, a central axis of a discharge side of the solid content discharge portion is inclined downward with respect to the central axis of the aeration portion, and an angle of inclination of the central axis of the discharge side with respect to the central axis of the aeration portion is 20° to 80°. Preferably, the aeration holes are arranged on an upper side of the aeration portion, and centers of the aeration holes coincide with the vertical cross section including the central axis of the aeration portion. Preferably, the aeration portion does not have an opening other than the aeration holes in a circumferential surface thereof. Preferably, a central axis of a connection side of the solid content discharge portion connected to the aeration portion is curved.

### TECHNICAL FIELD

The present invention relates to an aeration tube and a filtration unit. The present application is based upon and claims the benefit of priority from Japanese Patent Application No. 2016-010952, filed Jan. 22, 2016, the entire contents of which are incorporated herein by reference.

### BACKGROUND ART

Filtration units including filtration modules, in which a plurality of hollow fiber membranes are bundled, have been used as solid-liquid separation treatment apparatuses in sewage treatment and in processes for producing pharmaceuticals and the like. Such filtration units are used while being immersed in a liquid to be treated. Permeation of impurities contained in the liquid to be treated is prevented at the surfaces of the hollow fiber membranes, and permeation of the liquid other than the impurities into the inside is allowed. Thereby, filtration treatment is carried out.

However, in such filtration units, since permeation of impurities contained in the liquid to be treated is prevented at the surfaces of the hollow fiber membranes, impurities which have not been allowed to permeate into the inside adhere to the surfaces of the hollow fiber membranes. Accordingly, in the filtration units, there is a concern that filtration efficiency for the liquid that should be filtered may be decreased due to the impurities adhering to the surfaces of the hollow fiber membranes.

In view of the problem described above, in a structure employed to date, a gas is introduced into spaces between a plurality of hollow fiber membranes constituting a filtration module, and impurities adhering to the surfaces of the hollow fiber membranes are removed by the gas. A filtration unit having such a structure is proposed, for example, in the “Filtration module and filtration apparatus using the same” (refer to Japanese Unexamined Patent Application Publication No. 2009-154032).

A filtration unit described in the patent application publication described above includes an aeration tube which discharges a gas into spaces between a plurality of hollow fiber membranes constituting a filtration module. In the filtration unit, the aeration tube has a plurality of gas discharge ports. The gas discharged from the gas discharge ports abrades the surfaces of the hollow fiber membranes and further oscillates the hollow fiber membranes, and thereby, impurities can be removed.

### CITATION LIST

### Patent Literature

PTL 1: Japanese Unexamined Patent Application Publication No. 2009-154032

However, in the aeration tube described above, although it is possible to clean the hollow fiber membranes by discharging a gas from the gas discharge ports, there is a concern that solid contents, such as impurities, may enter the inside of the aeration tube from the gas discharge ports. Furthermore, when the solid contents that have entered are retained inside, there is a concern that the inside of the aeration tube may be contaminated or the flow of the gas inside the aeration tube may deteriorate.

### SUMMARY OF INVENTION

### Solution to Problem

An aeration tube according to an embodiment of the present invention, which is configured to supply a cleaning gas for a filtration unit, includes a straight tubular aeration portion, into one end of which the cleaning gas is force-fed and which has a plurality of aeration holes, and a tubular solid content discharge portion which extends from another end of the aeration portion. In a vertical cross section including a central axis of the aeration portion, a central axis of a discharge side of the solid content discharge portion is inclined downward with respect to the central axis of the aeration portion, and an angle of inclination of the central axis of the discharge side with respect to the central axis of the aeration portion is 20° to 80°.

A filtration unit according to another embodiment of the present invention includes a filtration module including a plurality of hollow fiber membranes, and a gas supply module configured to supply bubbles from below the filtration module. The gas supply module includes a gas force feeding device and an aeration tube one end of which is connected to the gas force feeding device. The aeration tube includes a straight tubular aeration portion, into one end of which a cleaning gas is force-fed and which has a plurality of aeration holes, and a tubular solid content discharge portion which extends from another end of the aeration portion. In a vertical cross section including a central axis of the aeration portion, a central axis of a discharge side of the solid content discharge portion is inclined downward with respect to the central axis of the aeration portion, and an angle of inclination of the central axis of the discharge side with respect to the central axis of the aeration portion is 20° to 80°.

### BRIEF DESCRIPTION OF DRAWINGS

FIG. 1 is a schematic side view showing an aeration tube according to an embodiment of the present invention.

FIG. 2 is a schematic diagram showing a filtration unit according to an embodiment of the present invention.

FIG. 3 is a graph showing the relationship between the angle of inclination of the central axis of the discharge side with respect to the central axis of the aeration portion and the sludge discharge time in an example which used a sludge having an MLSS concentration of 8,000 mg/L.

FIG. 4 is a graph showing the relationship between the angle of inclination of the central axis of the discharge side with respect to the central axis of the aeration portion and the sludge discharge time in an example which used a sludge having an MLSS concentration of 50,000 mg/L.

### DESCRIPTION OF EMBODIMENTS

### Problems to be Solved by the Present Disclosure

The present invention has been made under the circumstances as described above, and it is an object of the invention to provide an aeration tube which can prevent solid contents from being retained inside thereof and a filtration unit using the aeration tube.

### Advantageous Effects of the Present Disclosure

The aeration tube of the present invention can prevent solid contents from being retained inside thereof. Furthermore, the filtration unit of the present invention has excellent cleaning efficiency for hollow fiber membranes because retention of solid contents inside the aeration tube can be prevented.

### Description of Embodiments of the Present Invention

First, embodiments of the present invention will be described one by one.

An aeration tube according to an embodiment of the present invention, which is configured to supply a cleaning gas for a filtration unit, includes a straight tubular aeration portion, into one end of which the cleaning gas is force-fed and which has a plurality of aeration holes, and a tubular solid content discharge portion which extends from another end of the aeration portion. In a vertical cross section including a central axis of the aeration portion, a central axis of a discharge side of the solid content discharge portion is inclined downward with respect to the central axis of the aeration portion, and an angle of inclination of the central axis of the discharge side with respect to the central axis of the aeration portion is 20° to 80°.

Since the aeration tube includes the solid content discharge portion that is inclined at a certain angle downward and continuous with respect to the aeration portion which supplies the cleaning gas, retention of solid contents inside can be prevented by the solid content discharge portion. That is, in the aeration tube, since the angle of inclination of the solid content discharge portion is within the range described above, solid contents that have entered the aeration portion can be smoothly discharged from an outlet (an end opposite to the aeration portion) of the solid content discharge portion by the pressure of the gas. Consequently, the aeration tube can prevent the retention of solid contents without hindering the supply of the cleaning gas to a filtration module.

Preferably, the aeration holes are arranged on an upper side of the aeration portion, and centers of the aeration holes coincide with the vertical cross section including the central axis of the aeration portion. By thus arranging the aeration holes on the upper side of the aeration portion, the discharge of solid contents from the solid content discharge portion can be facilitated, and the gas can be easily and reliably discharged from a gas layer formed inside the tube.

Preferably, the aeration portion does not have an opening other than the aeration holes in a circumferential surface thereof. Since the aeration portion has only the aeration holes formed on the upper side in such a manner, the effect of discharging solid contents can be significantly promoted.

Preferably, a central axis of a connection side of the solid content discharge portion connected to the aeration portion is curved. Since a connecting portion of the solid content discharge portion to the aeration portion is smoothly continuous in such a manner, the pressure loss is decreased, and the discharge of solid contents from the solid content discharge portion can be facilitated.

A filtration unit according to an embodiment of the present invention includes a filtration module including a plurality of hollow fiber membranes, and a gas supply module configured to supply bubbles from below the filtration module. The gas supply module includes a gas force feeding device and an aeration tube one end of which is connected to the gas force feeding device. The aeration tube includes a straight tubular aeration portion, into one end of which a cleaning gas is force-fed and which has a plurality of aeration holes, and a tubular solid content discharge portion which extends from another end of the aeration portion. In a vertical cross section including a central axis of the aeration portion, a central axis of a discharge side of the solid content discharge portion is inclined downward with respect to the central axis of the aeration portion, and an angle of inclination of the central axis of the discharge side with respect to the central axis of the aeration portion is 20° to 80°.

In the filtration unit, the aeration tube of the gas supply module includes the solid content discharge portion that is inclined at a certain angle downward and continuous with respect to the aeration portion which supplies the cleaning gas, and retention of solid contents inside can be prevented by the solid content discharge portion. Therefore, the filtration unit can prevent the retention of solid contents inside the aeration tube, and the filtration module can be cleaned efficiently.

In the present invention, the terms “upper side” and “lower side” mean respectively an upper side and a lower side with respect to a horizontal plane including the central axis of the aeration portion. The phrase “central axis of the discharge side of the solid content discharge portion” means a straight line joining the center in the axial direction of the solid content discharge portion and the center of an end (outlet) of the solid content discharge portion. The sentence “the center of the aeration hole coincides with the vertical cross section” refers to a situation where an angle between a straight line passing through the center of the aeration hole and intersecting the central axis of the aeration tube and the vertical cross section is within ±10°, and preferably within ±5°. The filtration unit can be used either as an immersion-type filtration unit or as an external pressure-type filtration unit. Furthermore, the filtration unit is used in ultrafiltration or microfiltration. Among these, preferred is use in ultrafiltration.

### Detailed Description of Embodiments of the Present Invention

An aeration tube and a filtration unit according to embodiments of the present invention will be described with reference to the drawings appropriately.

[Aeration Tube]

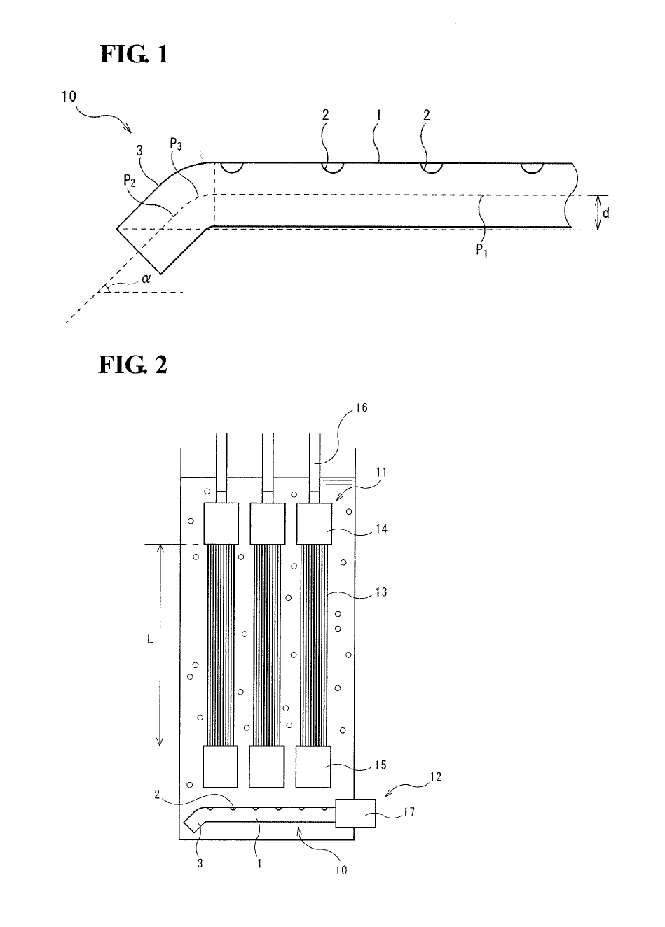

An aeration tube 10 shown in FIG. 1 is configured to supply a cleaning gas for a filtration unit. The filtration unit, for example, includes a filtration module including a plurality of hollow fiber membranes, and a gas supply module configured to supply bubbles from below the filtration module. The aeration tube 10 is used in the gas supply module. The aeration tube 10 is used while being immersed in a liquid to be treated.

The aeration tube 10 includes a straight tubular aeration portion 1, into one end (on the right side in drawing) of which the cleaning gas is force-fed and which has a plurality of aeration holes 2, and a tubular solid content discharge portion 3 which extends from another end of the aeration portion 1. The aeration tube 10 is placed such that a central axis P1 of the aeration portion 1 extends in a horizontal direction, and a central axis P2 of a discharge side of the solid content discharge portion 3 is included in a vertical cross section.

<Aeration Portion>

The aeration portion 1 discharges the force-fed cleaning gas upward from the aeration holes 2 and is formed in a straight tubular shape. Furthermore, the cross-sectional shape in the axial direction of the aeration portion 1 is not particularly limited, but can be, for example, circular or quadrilateral. The aeration portion 1 is provided with a plurality of aeration holes 2 arranged on an upper side thereof and discretely in the axial direction. While transferring a gas introduced from one end in the axial direction toward the other end, the aeration portion 1 cleans the filtration module by discharging the gas upward from the aeration holes 2.

As a main component of the aeration portion 1, for example, a metal, such as stainless steel, steel, copper, or aluminum, or a synthetic resin, such as an acrylic resin, polyethylene, polyvinyl chloride, or acrylonitrile-butadiene-styrene copolymer (ABS resin), may be used. Among them, preferable is polyvinyl chloride that has excellent durability and is relatively inexpensive.

In the aeration portion 1, when a gas is introduced from one end in the axial direction to the inside, a gas layer and a liquid layer (liquid-to-be-treated layer) are formed inside. That is, since the aeration portion 1 is used while being immersed in a liquid to be treated, the aeration portion 1 is filled with the liquid to be treated before introduction of the gas. Under this condition, when a gas is introduced from one end, since the gas has a lower specific gravity than the liquid to be treated, the gas flows between an inner wall on the upper side of the aeration portion 1 and the liquid to be treated. As a result, the inside of the aeration portion 1 is in a two-layer state including a gas layer consisting of the gas and a liquid layer located on the lower side of the gas layer. Furthermore, since the aeration tube 10 has a plurality of aeration holes 2 arranged discretely in the axial direction of the aeration portion 1, by discharging the gas from the aeration holes 2, it is easy to balance the gas introduced into the inside with the gas discharged to the outside. Consequently, the two-layer state including the gas layer and the liquid layer can be stably maintained in the aeration tube 10.

The gas to be introduced into the aeration tube 10 needs to have a lower specific gravity than the liquid to be treated because it is necessary to form a gas layer on the upper side inside the aeration portion 1. Furthermore, an inert gas is preferable as the gas to be introduced into the aeration tube 10. Typically, air is used as such a gas, although not particularly limited.

The lower limit of the inside diameter of the aeration portion 1 is preferably 6 mm, more preferably 10 mm, and still more preferably 15 mm. On the other hand, the upper limit of the inside diameter of the aeration portion 1 is preferably 70 mm, more preferably 60 mm, and still more preferably 50 mm. When the inside diameter of the aeration portion 1 is less than the lower limit, there is a concern that the gas layer and the liquid layer may not be appropriately formed inside the aeration portion 1. Contrarily, when the inside diameter of the aeration portion 1 exceeds the upper limit, the inside volume of the tube increases, and there is a concern that solids, such as impurities, are likely to be retained inside. Furthermore, in the aeration portion 1, as the gas is transferred from one end toward the other end, the liquid to be treated constituting the liquid layer also flows from the one end toward the other end, and solid contents retained inside the tube can be transferred to the solid content discharge portion 3, which will be described later, by the flow of the liquid to be treated. However, when the inside diameter exceeds the upper limit, the percentage occupied by the liquid layer inside the tube is likely to increase, and there is a concern that flow of the liquid to be treated due to the introduction of the gas cannot be achieved sufficiently, resulting in a decrease in solid-content discharge efficiency. In the case where the cross-sectional shape in the axial direction of the aeration portion 1 is other than a circular shape, the inside diameter refers to the inside diameter when the shape is converted to a perfect circle.

The lower limit of the average tube thickness of the aeration portion 1 is preferably 1 mm and more preferably 2 mm. On the other hand, the upper limit of the average tube thickness of the aeration portion 1 is preferably 6 mm and more preferably 4 mm. When the average tube thickness of the aeration portion 1 is less than the lower limit, there is a concern that sufficient strength may not be obtained. Contrarily, when the average tube thickness of the aeration portion 1 exceeds the upper limit, there is a concern that the outside diameter may increase unnecessarily.

The shape of the aeration holes 2 of the aeration portion 1 is not particularly limited, but is preferably circular. As shown in FIG. 1, the aeration holes 2 have the same size and are arranged at even intervals in the axial direction of the aeration portion 1. Since the aeration holes 2 are arranged at even intervals in the axial direction, while transferring the gas introduced from one end toward the other end, the aeration tube 10 can discharge the gas evenly or substantially evenly along the axial direction. Note that the aeration holes 2 can be formed in the aeration portion 1, for example, by laser machining.

Furthermore, centers of the aeration holes 2 are arranged so as to coincide with the vertical cross section including the central axis P1 of the aeration portion 1. That is, the centers of the aeration holes 2 are included in the vertical cross section including the central axis P1 of the aeration portion 1. Furthermore, the aeration portion 1 does not have an opening other than the aeration holes 2 in a circumferential surface thereof. In the aeration tube 10, since the aeration holes 2 are arranged in such a manner, a gas layer can be easily and reliably formed inside the tube, and the cleaning gas can be continuously discharged. At the same time, since the pressure inside the aeration portion 1 is likely to increase, solid contents can be easily pushed out toward the solid content discharge portion 3.

The lower limit of the average diameter of the aeration holes 2 is preferably 1 mm and more preferably 2 mm. On the other hand, the upper limit of the average diameter of the aeration holes 2 is preferably 10 mm and more preferably 8 mm. When the average diameter is less than the lower limit, there is a concern that the aeration holes 2 may not be able to discharge the gas sufficiently. Contrarily, when the average diameter exceeds the upper limit, the amount of the gas discharged from the aeration holes 2 increases excessively. As a result, in the case where a gas is introduced from one end, there is a concern that the gas may be excessively discharged from aeration holes 2 arranged on the one end side, and the amount of the gas discharged from the other end side may become insufficient. In the case where the shape of the aeration holes 2 is other than a circular shape, the average diameter refers to the average diameter when the shape is converted to a perfect circle.

The lower limit of the average pitch (center-to-center distance) between the aeration holes is preferably 10 mm and more preferably 20 mm. On the other hand, the upper limit of the average pitch between the aeration holes 2 is preferably 150 mm and more preferably 100 mm. When the average pitch is less than the lower limit, in the case where a gas is introduced from one end, there is a concern that the gas may be excessively discharged from aeration holes 2 arranged on the one end side, and the amount of the gas discharged from the other end side may become insufficient. Contrarily, when the average pitch exceeds the upper limit, there is a concern that regions to which the gas is hardly supplied may occur in the filtration module.

The lower limit of the ratio of the average diameter of the aeration holes 2 to the outlet diameter of the solid content discharge portion 3, which will be described later, is preferably 1/20 and more preferably 1/10. On the other hand, the upper limit of the ratio is preferably ⅓ and more preferably ¼. When the ratio is less than the lower limit, there is a concern that the gas may not be discharged sufficiently. Contrarily, when the ratio exceeds the upper limit, the amount of the gas discharged from the aeration holes 2 increases excessively. As a result, there is a concern that solid contents may be hardly discharged from the solid content discharge portion 3.

<Solid Content Discharge Portion>

The solid content discharge portion 3 discharges the solid contents inside the aeration tube and is a tubular body one end of which is connected to the other end (an end opposite to the end into which the gas is force-fed) of the aeration portion 1. The solid content discharge portion 3 excluding a connecting portion (connection side) connected to the aeration portion 1 is at least formed in a straight tubular shape. Furthermore, the material, inside diameter, tube thickness, and the like of the solid content discharge portion 3 can be same as those of the aeration portion 1. However, the material, inside diameter, and tube thickness of the solid content discharge portion 3 may be different from those of the aeration portion 1. The solid content discharge portion 3 may be integrally molded with the aeration portion 1. Alternatively, the solid content discharge portion 3 may be a tubular body having an inside diameter that is same as the outside diameter of the aeration portion 1 and engaged with the other end of the aeration portion 1, or a tubular body having an outside diameter that is same as the inside diameter of the aeration portion 1 and engaged with the other end of the aeration portion 1.

In the vertical cross section including the central axis P1 of the aeration portion 1, the central axis P2 of the discharge side of the solid content discharge portion 3 is inclined downward with respect to the central axis P1 of the aeration portion 1. The lower limit of an angle of inclination (α) of the central axis P2 of the discharge side of the solid content discharge portion 3 with respect to the central axis P1 of the aeration portion 1 is 20°, preferably 25°, and more preferably 30°. On the other hand, the upper limit of the angle of inclination (α) is 80°, preferably 70°, and more preferably 60°. When the angle of inclination (α) is less than the lower limit, there is a concern that the gas introduced from one end of the aeration portion 1 may be discharged from the outlet of the solid content discharge portion 3 before forming a gas layer, resulting in a situation where the gas cannot be supplied from the aeration portion 1. Contrarily, when the angle of inclination (α) exceeds the upper limit, there is a concern that solid contents may be hardly discharged from the solid content discharge portion 3.

In the aeration tube 10, when the angle of inclination of the solid content discharge portion 3 is equal to or less than the upper limit, solid contents that have entered the aeration portion 1 can be smoothly discharged from an outlet (an end opposite to the aeration portion 1) of the solid content discharge portion 3 by the pressure of the gas. Furthermore, in the aeration tube 10, when the angle of inclination of the solid content discharge portion 3 is equal to or more than the lower limit, the gas introduced into the aeration portion 1 can be prevented from being discharged from the solid content discharge portion 3. As a result, the aeration tube 10 can prevent the retention of solid contents without hindering the supply of the cleaning gas.

Preferably, a central axis P3 of the connection side of the solid content discharge portion 3 connected to the aeration portion 1 is curved as shown in FIG. 1. That is, the inner surface of a connecting portion of the solid content discharge portion 3 to the aeration portion 1 may be an R-surface. Specifically, the central axis P3 of the connection side preferably is circular arc-shaped, and more preferably has a shape having a circular arc and transition curves connected to both ends of the circular arc. Since the connecting portion of the solid content discharge portion 3 to the aeration portion 1 is smoothly continuous in such a manner, the pressure loss is decreased, and the discharge of solid contents from the solid content discharge portion 3 can be facilitated.

The orientation (angle of inclination) of an outlet end (an end opposite to the aeration portion 1) of the solid content discharge portion 3 is not particularly limited, but is preferably perpendicular to the central axis P2 of the discharge side from the viewpoint of solid content discharge performance.

The lower limit of a vertical distance d between the upper end of the solid content discharge portion 3 and the central axis P1 of the aeration portion 1 is preferably 10 mm and more preferably 20 mm. On the other hand the upper limit of the vertical distance d is preferably 150 mm and more preferably 140 mm. When the vertical distance d is less than the lower limit, there is a concern that the gas introduced from one end of the aeration portion 1 may be discharged from the outlet of the solid content discharge portion 3 before forming a gas layer, resulting in a situation where the gas cannot be supplied from the aeration portion 1. Contrarily, when the vertical distance d exceeds the upper limit, there is a concern that the external size of the aeration tube 10 may increase unnecessarily.

[Filtration Unit]

A filtration unit shown in FIG. 2 includes a plurality of filtration modules 11 and a gas supply module 12 configured to supply bubbles from below the filtration modules 11.

<Filtration Module>

A filtration module 11 includes a plurality of hollow fiber membranes 13, an upper holding member 14 that holds the upper ends of the hollow fiber membranes 13, and a lower holding member 15 that holds the lower ends of the hollow fiber membranes 13. The hollow fiber membranes 13 are arranged in parallel in the upward-downward direction. The hollow fiber membranes 13 are joined to the entire, or substantially entire, lower surface of the upper holding member 14 and the entire, or substantially entire, upper surface of the lower holding member 15.

A plurality of filtration modules 11 are arranged in a stripe pattern. More particularly, the filtration modules 11 are arranged in lines with a predetermined distance between adjacent filtration modules 11 in the thickness direction.

(Hollow Fiber Membrane)

A hollow fiber membrane 13 is obtained by forming, into a tubular shape, a porous membrane which allows water to permeate therethrough and blocks permeation of impurities contained in a liquid to be treated.

As the hollow fiber membrane 13, a material containing a thermoplastic resin as a main component can be used. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). Among these, preferable is PTFE which is excellent in terms of chemical resistance, heat resistance, weather resistance, flame resistance, and the like and which is porous, and more preferable is uniaxially or biaxially expanded PTFE. Other polymers and additives such as a lubricant may be appropriately mixed into the material for forming the hollow fiber membrane 13.

The lower limit of the average outside diameter of the hollow fiber membranes 13 is preferably 1 mm, more preferably 1.5 mm, and still more preferably 2 mm. On the other hand, the upper limit of the average outside diameter of the hollow fiber membranes 13 is preferably 6 mm, more preferably 5 mm, and still more preferably 4 mm. When the average outside diameter of the hollow fiber membranes 13 is less than the lower limit, there is a concern that the mechanical strength of the hollow fiber membranes 13 may become insufficient. Contrarily, when the average outside diameter of the hollow fiber membranes 13 exceeds the upper limit, because of insufficient flexibility of the hollow fiber membranes 13, the vibration and oscillation of the hollow fiber membranes 13 due to contact with a gas become insufficient. As a result, there is a concern that it may not be possible to guide the gas to the central part of the bundle of hollow fiber membranes 13 by enlarging spaces between hollow fiber membranes 13, and that the ratio of surface area to cross-sectional area of the hollow fiber membranes 13 may decrease, resulting in a decrease in filtration efficiency.

The lower limit of the average inside diameter of the hollow fiber membranes 13 is preferably 0.3 mm, more preferably 0.5 mm, and still more preferably 0.9 mm. On the other hand, the upper limit of the average inside diameter of the hollow fiber membranes 13 is preferably 4 mm and more preferably 3 mm. When the average inside diameter of the hollow fiber membranes 13 is less than the lower limit, there is a concern that the pressure loss at the time of discharging a filtrated liquid inside the hollow fiber membranes 13 may increase. Contrarily, when the average inside diameter of the hollow fiber membranes 13 exceeds the upper limit, there is a concern that mechanical strength and the effect of blocking permeation of impurities may become insufficient because of a decrease in the thickness of the hollow fiber membranes 13.

The lower limit of the ratio of the average inside diameter to the average outside diameter of the hollow fiber membranes 13 is preferably 3/10, and more preferably ⅖. On the other hand, the upper limit of the ratio of the average inside diameter to the average outside diameter of the hollow fiber membranes 13 is preferably ⅘, and more preferably ⅗. When the ratio of the average inside diameter to the average outside diameter of the hollow fiber membranes 13 is less than the lower limit, there is a concern that the thickness of the hollow fiber membranes 13 may increase more than necessary to decrease the permeability of the hollow fiber membranes 13. Contrarily, when the ratio of the average inside diameter to the average outside diameter of the hollow fiber membranes 13 exceeds the upper limit, there is a concern that mechanical strength and the effect of blocking permeation of impurities may become insufficient because of a decrease in the thickness of the hollow fiber membranes 13.

The lower limit of the average effective length L of the hollow fiber membranes 13 is preferably 1 m, and more preferably 2 m. On the other hand, the upper limit of the average effective length L of the hollow fiber membranes 13 is preferably 6 m, and more preferably 5 m. When the average effective length L of the hollow fiber membranes 13 is less than the lower limit, the oscillation of the hollow fiber membranes 13 due to abrasion by the gas becomes insufficient, and there is a concern that it may not be possible to guide the gas to the central part of the bundle of hollow fiber membranes 13 by enlarging spaces between hollow fiber membranes 13. Contrarily, when the average effective length L of the hollow fiber membranes 13 exceeds the upper limit, there is a concern that the deflection of the hollow fiber membranes 13 may be excessively increased by the own weight of the hollow fiber membranes 13 and that the handleability of the filtration module 11 during installation and the like may be decreased. Note that the “average effective length of the hollow fiber membranes” refers to the average length in the axial direction of portions arranged between the lower end of the upper holding member 14 and the upper end of the lower holding member 15.

Furthermore, each of the hollow fiber membranes 13 preferably has a multilayer structure including a support layer arranged on the inner surface side and a filtration layer disposed on the outer surface side of the support layer. By forming the hollow fiber membrane 13 so as to have such a multilayer structure, both permeability and mechanical strength can be achieved, and the effect of surface cleaning by the gas can be made effective.

The support layer and the filtration layer each may be formed of a material containing polytetrafluoroethylene (PTFE) as a main component. By forming each of the support layer and the filtration layer by using a material containing PTFE as a main component, the hollow fiber membranes 13 can have excellent mechanical strength, and the surfaces of the hollow fiber membranes are unlikely to sustain damage or the like due to abrasion by the gas. Note that the filtration layer can be formed, for example, by winding a PTFE sheet around the support layer, followed by sintering.

(Upper Holding Member)

The upper holding member 14 is a member that holds the upper ends of a plurality of hollow fiber membranes 13 and has a discharge portion (water-collecting header) which communicates with hollow portions of the hollow fiber membranes 13 and collects a filtrated liquid. A discharge pipe 16 is connected to the discharge portion to discharge the filtrated liquid which has permeated into the hollow fiber membranes 13.

(Lower Holding Member)

The lower holding member 15 is a member that holds the lower ends of a plurality of hollow fiber membranes 13. The lower holding member 15 may have the same structure as that of the upper holding member 14 or may have a structure, without a discharge portion, which seals the lower ends of the hollow fiber membranes 13.

Furthermore, the lower holding member 15 may have a structure in which one hollow fiber membrane 13 is bent in U-shape and folded back. In this case, the upper holding member 14 holds both ends of the hollow fiber membrane 13.

Furthermore, in order to facilitate handling (transport, installation, replacement, etc.) of the filtration module 11, the upper holding member 14 and the lower holding member 15 may be joined with each other by a joining member. As the joining member, for example, a supporting bar made of metal, a casing (external cylinder) made of resin, or the like may be used.

<Gas Supply Module>

The gas supply module 12 includes a gas force feeding device 17 and an aeration tube 10 including an aeration portion 1 one end of which is connected to the gas force feeding device 17. The aeration tube 10 is arranged such that the axial direction of the aeration portion 1 is parallel to the thickness direction of the filtration modules 11 (left-right direction in FIG. 2). Furthermore, in the filtration unit, a plurality of aeration tubes 10 are arranged at a predetermined distance from one another in the width direction of the filtration modules 11 (in the front-rear direction in FIG. 2). The gas force feeding device 17 is not particularly limited, and for example, a known blower or compressor may be used. Furthermore, the aeration tube 10 and the gas compression device 17 may be connected to each other, for example, through a feed pipe (not shown).

In the filtration unit, since the gas supply module 12 includes the aeration tube 10, it is possible to prevent solid contents from being retained inside the aeration tube 10, and the filtration module 11 can be cleaned efficiently.

### Other Embodiments

It should be considered that the embodiments disclosed this time are illustrative and non-restrictive in all aspects. The scope of the present invention is not limited to the embodiments described above but is defined by the appended claims, and is intended to include all modifications within the meaning and scope equivalent to those of the claims.

The centers of a plurality of aeration holes of the aeration tube may not necessarily coincide with the vertical cross section including the central axis of the aeration portion. For example, a plurality of aeration holes may be arranged on the upper side and at positions deviated leftward or rightward from the central axis in a cross section perpendicular to the axial direction of the aeration portion. However, in order to enhance the solid content discharge function of the aeration tube, the centers of the aeration holes preferably coincide with the vertical cross section including the central axis of the aeration portion.

Furthermore, in the aeration tube, the aeration portion may have an opening other than the aeration holes. Examples of such an opening include an opening for discharging solid contents provided on the lower side of the aeration portion. However, when such an opening is provided, the pressure inside the aeration portion is unlikely to increase, and as a result, there is a concern that the solid content discharge function of the aeration tube may become insufficient. Therefore, preferably, the aeration portion does not have an opening other than the aeration holes in a circumferential surface thereof.

Moreover, a plurality of aeration holes do not necessarily need to be arranged at even intervals. For example, the pitch may gradually decrease or increase from one end to the other end, or the pitch may vary at random. Furthermore, a plurality of aeration holes may have different hole sizes.

Furthermore, the aeration tube may not include a straight tubular portion and may be an entirely curved tubular body.

The aeration tube can be used for cleaning various ultrafiltration devices, without being limited to a filtration module including a plurality of hollow fiber membranes.

### Examples

The present invention will be more specifically described below on the basis of examples. However, it is to be understood that the present invention is not limited to the examples.

Aeration tubes having a structure shown in FIG. 1 in which the angle of inclination of the central axis of the discharge side with respect to the central axis of the aeration portion was set to be 15°, 30°, 45°, 60°, 75°, or 90° were prepared. Air was force-fed into one end of each of the discharge tubes filled with a sludge, and by measuring the time until the sludge inside was completely discharged out of the tube, sludge discharge performance was evaluated. As the sludge, a sludge A having an MLSS (mixed liquor suspended solids) concentration of 8,000 mg/L and a sludge B having an MLSS concentration of 50,000 mg/L were used. The sludge A assumes a sludge during water treatment by a commonly used membrane bioreactor (MBR) process, and the sludge B assumes a concentrated sludge that accumulates inside the aeration tube.

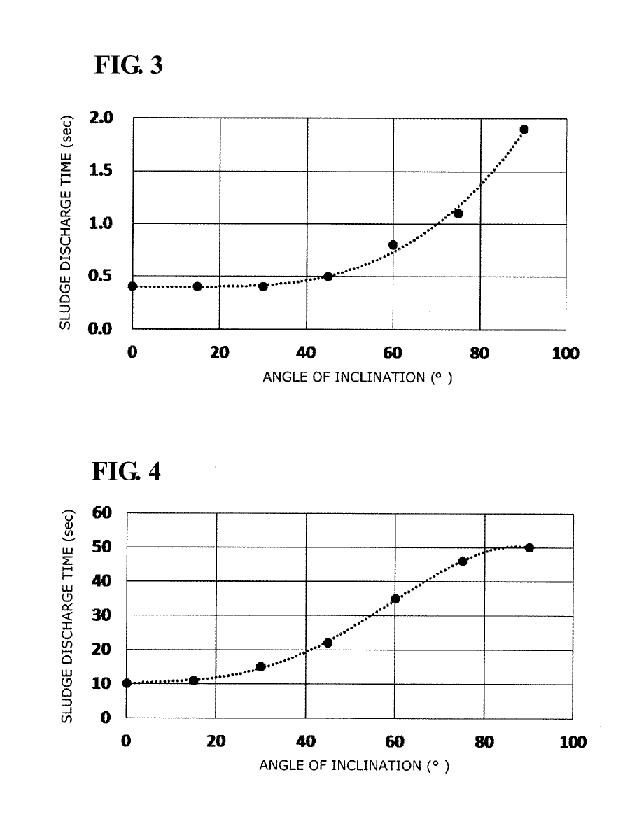

FIGS. 3 and 4 each show the relationship between the sludge discharge time and the angle of inclination of each of the aeration tubes. FIG. 3 shows the results when the sludge A was used, and FIG. 4 shows the results when the sludge B was used.

As is evident from FIGS. 3 and 4, by setting the angle of inclination to be 80° or less, the sludge discharge time is markedly reduced. As is evident from the sludge A (FIG. 3), by setting the angle of inclination to be 60° or less, the discharge time can be further reduced, and in particular, by setting the angle of inclination to be 45°, the discharge performance that is approximately four times better than that of the angle of inclination of 90° can be achieved.

### REFERENCE SIGNS LIST

1 aeration portion
2 aeration hole
3 solid content discharge portion
10 aeration tube
11 filtration module
12 gas supply module
13 hollow fiber membrane
14 upper holding member
15 lower holding member
16 discharge pipe
17 gas force feeding device
P1 central axis
P2 central axis of discharge side
P3 central axis of connection side

1. An aeration tube, which is configured to supply a cleaning gas for a filtration unit, comprising:
a straight tubular aeration portion, into one end of which the cleaning gas is force-fed and which has a plurality of aeration holes; and
a tubular solid content discharge portion which extends from another end of the aeration portion,
wherein, in a vertical cross section including a central axis of the aeration portion, a central axis of a discharge side of the solid content discharge portion is inclined downward with respect to the central axis of the aeration portion, and
an angle of inclination of the central axis of the discharge side with respect to the central axis of the aeration portion is 20° to 80°.

2. The aeration tube according to claim 1, wherein the aeration holes are arranged on an upper side of the aeration portion, and centers of the aeration holes coincide with the vertical cross section including the central axis of the aeration portion.

3. The aeration tube according to claim 2, wherein the aeration portion does not have an opening other than the aeration holes in a circumferential surface thereof.

4. The aeration tube according to claim 1, wherein a central axis of a connection side of the solid content discharge portion connected to the aeration portion is curved.

5. A filtration unit comprising:
a filtration module including a plurality of hollow fiber membranes; and
a gas supply module configured to supply bubbles from below the filtration module,
wherein the gas supply module includes a gas force feeding device and an aeration tube one end of which is connected to the gas force feeding device,
the aeration tube includes a straight tubular aeration portion, into one end of which a cleaning gas is force-fed and which has a plurality of aeration holes, and a tubular solid content discharge portion which extends from another end of the aeration portion,
in a vertical cross section including a central axis of the aeration portion, a central axis of a discharge side of the solid content discharge portion is inclined downward with respect to the central axis of the aeration portion, and
an angle of inclination of the central axis of the discharge side with respect to the central axis of the aeration portion is 20° to 80°.

6. The aeration tube according to claim 2, wherein a central axis of a connection side of the solid content discharge portion connected to the aeration portion is curved.

7. The aeration tube according to claim 3, wherein a central axis of a connection side of the solid content discharge portion connected to the aeration portion is curved.
